(19) United States
(12) Patent Application Publication
(10) Pub. No.: US 2002/0009540 A1
(43) Pub. Date: Jan. 24, 2002

(54) Insulating method of carbon filament and method for forming a coaxial cable with carbon filament and electric conductor

(76) Inventor: Tuneji Sasaki, Nagareyama-shi (JP)

Correspondence Address: MATTINGLY, STANGER & MALUR, P.C., ATTORNEYS AT LAW, 104 EAST HUME AVENUE, ALEXANDRIA, VA, 22301, US

(21) Appl. No.: 09/756,923

(22) Filed: Jan. 10, 2001

(30) Foreign Application Priority Data
Jan. 11, 2000 (JP) 2000-6162
Jan. 9, 2001 (JP) 2001-1821

(51) Int. Cl. B05D 5/12

(52) U.S. Cl. 427/117; 252/511

(57) ABSTRACT

It is particularly an object of the present invention to provide a method for insulating a heater element and carbon filaments which prevent an insulating material from peeling off due to thermal expansion or air expansion, which exhibit the enhanced insulation performance and realize heat resistance and incombustibility, and which are electrically stable even in high temperature areas.

This invention comprises: a collecting and twisting step of collecting and twisting thousands to hundreds of thousands of polyacrylonitrile carbon filaments, thereby, forming a collected and twisted body; a first coating step of coating the surface of the collected and twisted body with a synthetic polymer resin, thereby forming a single-layer coated body having a first coating layer; and a second coating step of coating the surface of the single-layer coated body with a synthetic polymer resin, thereby forming a double-layer coated body having a second coating layer over the first coating layer.

### BACKGROUND OF THE INVENTION

1. Field of the Invention

This invention relates to a method for insulating carbon filaments which show a high elastic modulus and excellent fatigue resistance, which are chemically stable and will not be affected by acids, alkalies, or solvents, which have excellent radiolucency, which generate only trace amounts of electromagnetic waves, which can be utilized as a heater element for a heating and heat insulating device exhibiting excellent performance with regard to periodic damping and friction and wear resistance, and which are composite materials exhibiting good workability and high performance. This invention also relates to a device having, as a heater element, a carbon filament insulator processed, by the above-described insulating method.

2. Description of the Related Art

The most generally used heater elements in heating and heat insulating devices such as heaters are electric conductors such as nichrome wires or copper wires. Moreover, it is desirable that the heater elements be insulators because of the requirement of an element that prevents the occurrence of leaks and short circuits. Accordingly, insulation treatment is applied to nichrome wires or copper wires which are used as the heater elements. Examples of methods for insulating such electric conductors include a method of sheath coating the electric conductors with vinyl chloride, polyethylene resin, rubber, silicon resin, or the like.

However, since the nichrome wires or copper wires themselves are rigid and lack elasticity, their drawback is that they are vulnerable to vibrations and, therefore, they tend to be easily broken.

Recently, heating products which utilize, as the heater elements, sheet-type heating units including carbon filaments have been developed and distributed in the market. Examples of methods for insulating the carbon filaments used for such sheet-type heating units include a method of: mixing chopped fibers of PAN (polyacrylonitrile) carbon filaments, which are cut in a fiber length (or filament length) of 0.5 mm to 2 mm, into paper or resin as a binder to obtain a sheet object; affixing a silver paste or a copper foil tape as an electrode material to both edges of the sheet object; and then, as necessary, performing press coating with a polyethylene terephthalate film or an epoxy resin, or vulcanized rubber molding.

However, in the above-described carbon filament insulating method, the carbon filaments used as the electric conductor for the heater element are the chopped fibers which are cut. Accordingly, contacts between the filaments are point contacts which make them electrically unstable. Particularly in areas at temperatures of about 100° C., the carbon filaments may peel off from the surface of the sheet object due to thermal expansion or the resin serving as the binder may peel off due to fatigue degradation. Moreover, in the case where coating is performed with a polyethylene terephthalate film or an epoxy resin or where vulcanized rubber molding is performed, air remaining inside the coating layer accelerates the peeling of the filaments or the resin due to thermal expansion. This results in such a drawback that incomplete insulation and abnormal heat generation frequently occur at electrode portions because the filaments or the resin peel off. Since a synthetic polymer material is used as an insulating material for insulating the carbon filaments, there are many dangers that incomplete insulation may be caused by the peeling of such material, short circuits may occur due to carbonization, and fire damage accidents may take place due to abnormal heat generation.

### SUMMARY OF THE INVENTION

It is an object of this invention to solve the above-described problems of the conventional method for insulating carbon filaments. Particularly, it is an object of this invention to provide a method for insulating a heater element and carbon filaments usable therefor, which prevent insulating material from peeling off due to thermal expansion or air expansion, which exhibit the enhanced insulation performance and realizes heat resistance and incombustibility, and which is electrically stable even in high temperature areas at temperatures of 200° C. or more by making use of the properties of the carbon filaments.

This invention achieves the above-described objects by providing a carbon filament insulating method (hereinafter referred to as the “first invention”) comprising: a collecting and twisting step of collecting and twisting thousands to hundreds of thousands of polyacrylonitrile carbon filaments, thereby forming a collected and twisted body; a first coating step of coating the surface of the collected and twisted body with a synthetic polymer resin, thereby forming a single-layer coated body having a first coating layer; and a second coating step of coating the surface of the single-layer coated body with a synthetic polymer resin, thereby forming a double-layer coated body having a second coating layer over the first coating layer.

Moreover, this invention provides a carbon filament insulating method (hereinafter referred to as the “second invention”) comprising: a collecting and twisting step of collecting and twisting thousands to hundreds of thousands of polyacrylonitrile carbon filaments, thereby forming a collected and twisted body; a resin coating step of coating the surface of the collected and twisted body with a synthetic polymer resin, thereby forming a single-layer coated body having a resin coating layer; and an incombustible treatment step of applying a braiding processing to the surface of the single-layer coated body by braiding, lengthwise and widthwise, more than one kind of fiber selected from a group consisting of glass fibers, silica glass fibers, alumina fibers, and aramid fibers, thereby forming a fiber braided body.

This invention provides a method for forming a coaxial body with carbon filaments and an electric conductor (hereinafter referred to as the “third invention”), comprising: a collecting and twisting step of collecting and twisting thousands to hundreds of thousands of polyacrylonitrile carbon filaments, thereby forming a collected and twisted body; a first coating step of coating the surface of the collected and twisted body with a synthetic polymer resin, thereby forming a single-layer coated body having a first coating layer; a second coating step of braiding and incorporating an electric conductor over the surface of the single-layer coated body, thereby forming a double-layer coated body having a second coating layer made of an electric conductor braided body over the first coating layer; and a third coating step of coating the surface of the double-layer coated body with a synthetic polymer resin, thereby forming a triple-layer coated body having a third coating layer over the second coating layer; wherein by the coaxial body forming method, connection with an electric supply source can be made without the intermediary of a lead wire.

### BRIEF DESCRIPTION OF THE DRAWINGS

FIG. 1 is a schematic perspective view of one example of a collected and twisted body formed by the insulating method of this invention.

FIG. 2(a) is a schematic perspective view of one example of a carbon filament insulator (or double coated body) obtained by the insulating method of this invention. (FIG. 2(a) shows the carbon filament insulator by partially omitting both a first coated layer and a second coated layer). FIG. 2(b) is a schematic sectional view of the carbon filament insulator of FIG. 2(a) as taken along the line A-A.

FIG. 3 is a schematic perspective view of one example of a fiber braided body to which the process of braiding is applied by performing lengthwise winding and widthwise winding of fibers in the course of the insulating method of this invention. (FIG. 3 shows a part of the fiber braided body by omitting both the lengthwise wound braid and the widthwise wound braid and also shows another part of the fiber braided body by omitting only the widthwise wound braid.)

FIG. 4 is a schematic perspective view of one example of a device which uses, as a heater element, the carbon filament insulator obtained by the insulating method of this invention.

FIG. 5(a) is a schematic perspective view of one example of a coaxial cable, with a part thereof omitted, which is obtained by the coaxial body forming method of this invention. FIG. 5(b) is a schematic sectional view of the coaxial cable of FIG. 5(a) as taken along line B-B.

FIG. 6 is a schematic perspective view of one example of (a part of) an elastic device formed by mounting an elastic body on the coaxial cable obtained by the coaxial body forming method of this invention.

FIG. 7 is a schematic view illustrative of a method for connecting the connection end of the elastic body mounted cable of the elastic device shown in FIG. 6.

### DESCRIPTION OF PREFERRED EMBODIMENTS

[Insulating Method of the First Invention]

A carbon filament insulating method of the first invention is first explained in detail.

The carbon filament insulating method of this invention comprises: (1) a collecting and twisting step of collecting and twisting thousands to hundreds of thousands of polyacrylonitrile carbon filaments, thereby forming a collected and twisted body; (2) a first coating step of coating the surface of the collected and twisted body with a synthetic polymer resin, thereby forming a single-layer coated body having a first coating layer; and (3) a second coating step of coating the surface of the single-layer coated body with a synthetic polymer resin with the addition of heat in a treatment vessel, thereby forming a double-layer coated body having a second coating layer over the first coating layer. Explanations will be given below about these respective steps.

(1) Collecting and Twisting Step

Polyacrylonitrile (hereinafter sometimes referred to as “PAN” ) carbon filaments used in this step contain polyacrylonitrile as their principal component. Moreover, such PAN carbon filaments can also be used which have been treated to acquire flame resistance, which have been carbonized, and which have undergone surface treatment.

A filament collected body which is made by previously collecting the above-described PAN carbon filaments, for example, such commercially available products as those called “BESFIGHT” (manufactured by Toho Rayon Co., Ltd.) or “TORAYCA” (manufactured by Toray Industries, Inc.), is used and is twisted, or a plurality of such commercially available products are used and a specified number of such filament collected bodies are collected and then twisted.

The fiber length (or filament length) of the PAN carbon filaments is not particularly limited. They may be as short as about 10 cm or may be as long as thousands of meters, but the PAN carbon filaments of 500 m to 1200 m are generally used. The fiber diameter (or filament thickness) of the PAN carbon filaments should preferably be in the range of 3 μm to 10 μm, or more preferably in the range of 5 μm to 8 μm.

Thousands to hundreds of thousands of the PAN carbon filaments are collected, preferably in the range of 1,000 to 200,000 pieces, or more preferably in the range of 2,000 to 120,000 pieces.

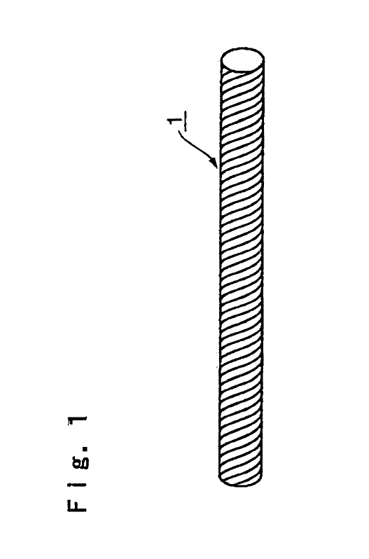

After they are collected, they are further twisted, thereby forming a collected and twisted body, for example, as shown in FIG. 1. This collected and twisted body has been twisted from 100 times per meter to 300 times per meter, or more preferably from 150 times per meter to 180 times per meter.

The thickness of the collected and twisted body should preferably be in the range of 0.5 mm to 10 mm, or more preferably in the range of 2 mm to 6 mm.

(2) First Coating Step

The surface of the collected and twisted body is coated with a synthetic polymer resin, thereby forming a single-layer coated body having a first coating layer.

There is no particular limitation on the type of synthetic polymer resin used in the first coating step.

Examples of the synthetic polymer resin used as the first coating layer include: epoxy resin, fluororesin, silicon resin, polyethylene resin, polybutylene terephthalate resin, polylimide resin, polyamide resin, polyvinyl chloride elastomer, polyurethane elastomer, chloroprene rubber, silicon rubber, fluororubber, and polyurethane rubber. Out of these resins, preferred types of resins are epoxy resin, fluororesin, polyimide resin, polyamide resin, and polyethylene resin (particularly, crosslinked polyethylene resin). Regarding these resins, one kind of resin may be solely used or two or more kinds of resins may be mixed and used. Moreover, among these synthetic polymer resins, epoxy resin is particularly preferred for the formation of the first coating layer. The thickness of the layer is not particularly limited, but should preferably be in the range of 0.05 mm to 1 mm, more preferably in the range of 0.03 mm to 0.8 mm, or most preferably in the range of 0.03 mm to 0.5 mm.

The coating treatment with the synthetic polymer resin is performed by spraying the synthetic polymer resin, with the addition of heat, over the surface of the collected and twisted body.

(3) Second Coating Step

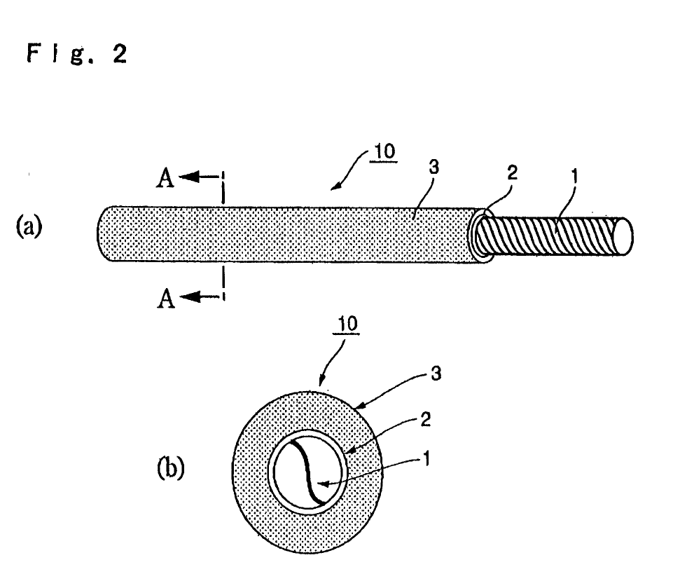

The surface of the single-layer coated body is coated with a synthetic polymer resin in a treatment vessel with the addition of heat, thereby forming a double-layer coated body having a second coating layer over the first coating layer (see FIG. 2).

There is no particular limitation on the type of the synthetic polymer resin used in the second coating step. Examples of the synthetic polymer resin used in this step include: epoxy resin, fluororesin, silicon resin, polyethylene resin, polybutylene terephthalate resin, polylimide resin, polyamide resin, polyvinyl chloride elastomer, polyurethane elastomer, chloroprene rubber, silicon rubber, fluororubber, and polyurethane rubber. Out of these resins, the above-listed resins excluding epoxy resin are preferred. Regarding these resins, one kind of resin may be solely used, or two or more kinds of resins may be mixed and used. Moreover, among these synthetic polymer resins, silicon resin, polyethylene resin (crosslinked polyethylene resin), polybutylene terephthalate resin, and fluororesin are particularly preferred for the formation of the second coating layer.

The thickness of the second coating layer should preferably be in the range of 0.3 mm to 10 mm, or more preferably in the range of 0.5 mm to 6 mm.

The coating treatment is performed, for example, by using the synthetic polymer resin in a colloidal state in a treatment vessel for electron beam irradiation sheath processing with the addition of heat preferably at temperatures of 180° C. to 250° C.

The thickness of the obtained double-layer coated body should preferably be in the range of 1 mm to 10 mm, or more preferably in the range of 1.75 mm to 8 mm.

As stated above, by the insulating method of this invention comprising the above-described steps (1) through (3), the double-layer coated body as a carbon filament insulator can be particularly obtained which prevents the insulating material from peeling off due to thermal expansion or air expansion, which realizes the enhanced insulation performance and further enhances water resistance, and which can be utilized as an electrically stable heater element.

Moreover, it is desirable in this invention that the third coating step described in the following section (4) be done because complete insulation treatment can be accomplished by the third coating step even when some twigs (or burrs) remain in the carbon filaments twisted into a rope or the like at the time of twisting.

(4) Third Coating Step

The surface of the second coating layer is coated with a synthetic polymer resin, thereby forming a triple-layer coated body having a third coating layer.

Examples of the synthetic polymer resin used in the third coating step are similar to those of the synthetic polymer resin used for the formation of the second coating layer.

The thickness and the coating method of the third coating layer are similar to those of the second coating layer in the second coating step. In this case, the advantageous effects of this invention can be exerted even if the respective thicknesses of the second and third coating layers are made slightly thinner than those without the third, coating layer.

The thickness of the obtained triple-layer coated body should preferably be in the range of 1 mm to 10 mm, or more preferably in the range of 2 mm to 8.5 mm.

[Insulating Method of the Second Invention]

A carbon filament insulating method of a second invention is hereinafter described in detail.

A carbon filament insulating method of this invention comprises: (I) a collecting and twisting step of collecting and twisting thousands to hundreds of thousands of polyacrylonitrile carbon filaments, thereby forming a collected and twisted body; (II) a resin coating step of coating the surface of the collected and twisted body with a synthetic polymer resin, thereby forming a single-layer coated body having a resin coating layer; and (III) an incombustible treatment step of applying a braiding processing to the surface of the single-layer coated body by braiding, lengthwise and widthwise, more than one kind of fiber selected from a group consisting of glass fibers, silica glass fibers, alumina fibers, and aramid fibers, thereby forming a fiber braided body. Explanations are, given below about these respective steps.

The collecting and twisting step (I) and the resin coating step (II) respectively correspond to and are exactly similar to the collecting and twisting step (1) and the first coating step (2) of the first invention as described above and the descriptions of these steps are applied as appropriate.

(III) Incombustible Treatment Step

After the resin coating step, the process of braiding is applied to the surface of the single-layer coated body by braiding, lengthwise and widthwise, more than one kind of fiber selected from a group consisting of glass fibers, silica glass fibers, alumina fibers, and aramid fibers.

Of the fibers mentioned above, silica glass fibers are particularly preferred.

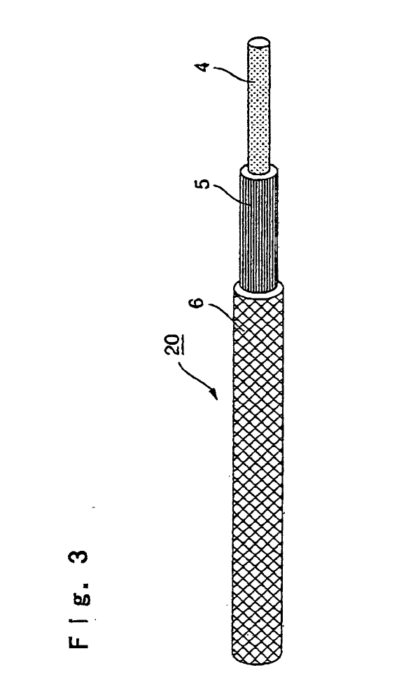

When the braiding process of the glass fibers is performed lengthwise and widthwise, the obtained fiber braided body is, for example, as shown in FIG. 3. Such braiding process brings about the advantageous effects of the enhancement of heat resistance and incombustibility.

As stated above, by the insulating method of this invention comprising the above-described steps (I) through (III), it is possible to obtain the fiber braided body as a carbon filament insulator which particularly prevents the insulating material from peeling off due to thermal expansion or air expansion, which enhances the insulation performance and realizes incombustibility, which is electrically stable even in high temperature areas at temperatures of 200° C. or more, particularly 300° C. or more, and which can be utilized as a heater element usable at public facilities or the like.

Regarding this invention, the waterproof treatment step (IV) described below may be done as necessary.

(IV) Waterproof Treatment Step

The surface of the fiber braided body is coated with a synthetic polymer resin, thereby forming a triple-layer coated body having a waterproof coating layer.

Examples of the synthetic polymer resin used in this step include waterproof synthetic resins such as silicon resin, fluororesin, polyimide resin, and polyethylene resin. Among these resins, silicon resin and fluororesin are preferred.

The thickness of the waterproof coating layer is not particularly limited, but should preferably be in the range of 0.05 mm to 4 mm, or more preferably in the range of 0.5 mm to 2 mm.

The coating treatment with the synthetic polymer resin is performed by applying the synthetic polymer resin with th e addition of heat to the surface of the resin coating layer and the fiber coated body by means of spraying or electron beam irradiation sheath processing.

It is desirable in this invention that after step (IV) or without step (IV), a press treatment step described in the following section (V) be done because such heater element will be obtained that exerts a far infrared radiation heat effect which is a synergy effect as a result of the exploitation of the electric stability in high temperature areas and such properties of an inorganic material as mica.

(V) Press Treatment Step

Hard or soft glued laminated mica is used to perform lamination press processing.

Specifically speaking, the fiber braided body or the triple-layer coated body is set on the hard or soft glued laminated mica in an unfinished state to some degree, to which heat press molding processing is applied through continuous press heat curing preferably at temperatures of 120° C. to 250° C., or more preferably from 180° C. to 200° C., and preferably for a period of time in the range of 8 hours to 12 hours, thereby obtaining a preferred thickness in the range of 1 mm to 5 mm, or more preferably in the range of 2 mm to 4 mm.

[Carbon Filament Insulator]

By the insulating methods of the first and second inventions described above, it is possible to perform the uniform insulation treatment continuously on thousands of meters of carbon filaments.

Any of the carbon filament insulators obtained by the insulating methods of the first and second inventions are flexible and are superior to insulators obtained by the conventional carbon filament insulating methods in terms of comprehensive properties such as elasticity, compressive strength, tensile strength, heat resistance, and waterproof.

Moreover, it is possible to provide a carbon heating unit of a multiple complex type or the like by using, as a heater element, the carbon filament insulator obtained by the insulating methods of the first and second inventions, by applying terminal finishing and electrode processing to such insulator, by either fixing the obtained insulator on the surface of a resin film sheet, an aluminum sheet, or a resin net or performing press molding with rubber compounds and pulverized rubber chips, and by further protecting the obtained insulator with such materials as stainless steel, ceramic, plastic, concrete, wood, or steel plate.

As materials for electrodes, it is possible to use wires, plates, and tapes of metallic materials such as platinum, gold, silver, copper, nickel silver, nickel, tin, or stainless steel. It is also possible to use crimp-style terminals which are made of such materials as tin, nickel, copper or the like and which are commercially available.

[Device]

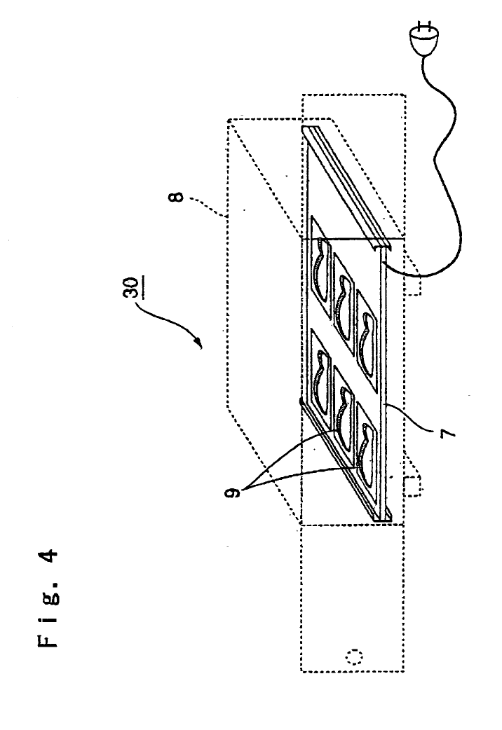

A device, such as a heating and heat insulating device as shown in FIG. 4, which uses, as the heater element, the carbon filament insulator obtained by the insulating methods of the first and second inventions has excellent far infrared radiation effect and radiant heat effect. A device 30 shown in FIG. 4, which is one example of the device using the above-described carbon filament insulator as the heater element, comprises: a carbon heating unit 7 which is obtained by applying the terminal treatment and the electrode processing to the carbon filament insulator as the heater element; and a heating case 8 with a door. The device 30 is a heating and heat insulating device for heating and thermally insulating a grilled fish package as an object to be processed 9.

By making use of the above-mentioned effects, the above-described device can be used, from the viewpoint of energy conservation and environmental conservation, in the broad industrial fields of medical care, thawing of foods or the like, heating and heat insulation of foods or the like, transportation, agriculture and forestry, fisheries, chemistry, services, and the like. The above-described device can be used, for example, for heating equipment and for snow melting and freeze proofing of road and railway related facilities.

[Coaxial Body Forming Method of the Third Invention]

Detailed explanations are given below about a method for forming a coaxial body with carbon filaments and an electric conductor according to a third invention.

The coaxial body forming method of this invention comprises: (a) a collecting and twisting step of collecting and twisting thousands to hundreds of thousands of polyacrylonitrile carbon filaments, thereby forming a collected and twisted body; (b) a first coating step of coating the surface of the collected and twisted body with a synthetic polymer resin, thereby forming a single-layer coated body having a first coating layer; (c) a second coating step of braiding and incorporating an electric conductor over the surface of the single-layer coated body, thereby forming a double-layer coated body having a second coating layer made of an electric conductor braided body over the first coating layer; and (d) a third coating step of coating the surface of the double-layer coated body with a synthetic polymer resin, thereby forming a triple-layer coated body having a third coating layer over the second coating layer; wherein by the coaxial body forming method, connection with an electric supply source can be made without the intermediary of a lead wire.

The collecting and twisting step (a), the first coating step (b), and the third coating step (c) respectively correspond to and are exactly similar to the collecting and twisting step (1), the first coating step (2), and the second coating step (3) of the first invention as described above and the descriptions of these step are applied as appropriate. Moreover, regarding the coaxial body forming method of this invention, double resin layers may be adopted as the first coating layer as necessary.

In the second coating step (c), the electric conductor is braided and incorporated into the surface of the single-layer coated body so as to form the coaxial body with the carbon filaments, thereby forming the double-layer coated body having the second coating layer made of the electric conductor braided body over the first coating layer. In this manner, the electric conductor braided body as the second coating layer is incorporated with the carbon filaments to form the coaxial body. Accordingly, with the coaxial cable obtained by the coaxial body forming method of this invention, it is unnecessary to provide any lead wires, such as electric cords, from an electric supply source. Therefore, by the coaxial body forming method of this invention, such treatment is given that the carbon filaments can be connected with the electric supply source without the intermediary of any lead wires.

By the coaxial body forming method of this invention, it is possible to obtain such coaxial cable that does not require a lead wire for connecting the end of the carbon filaments with the electric supply source to have such length as conventionally required, but can make the lead wire very short. Concerning a conventional cable, if a heater wire is, for example, 10 m to 50 m long, it is required that the length of the lead wire be also in the range of 10 m to 50 m. On the other hand, regarding the coaxial cable obtained by the coaxial body forming method of this invention, if the heater wire is, for example, 10 m to 50 m long as in the above-described case, the sufficient length of the lead wire is in the range of 5 cm to 10 cm. The expression “without the intermediary of a lead wire” as used with regard to this invention means that a lead wire is not substantially used, and includes the above-mentioned case where an extremely short lead wire is used. Moreover, the coaxial cable obtained by this invention has a slim shape and can enhance the workability.

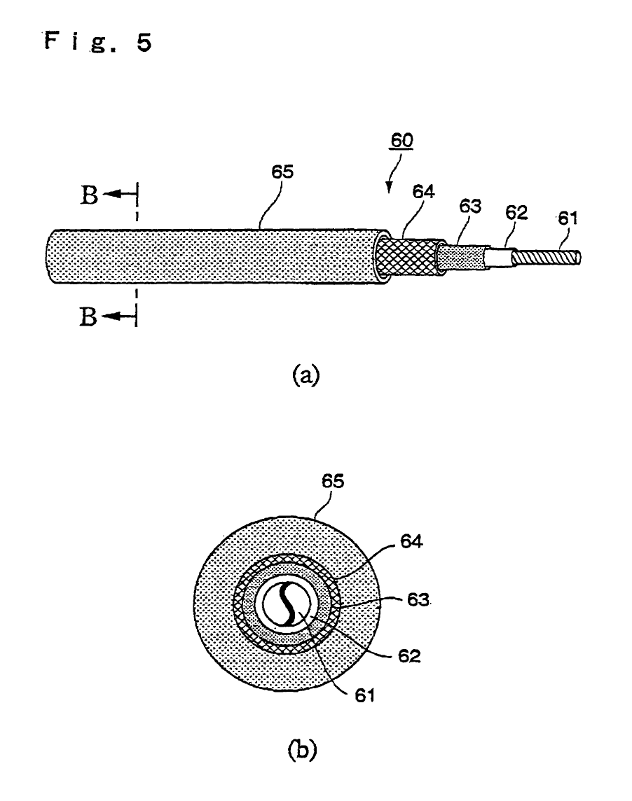

An example of a preferred embodiment of the coaxial body forming method of this invention is, as shown in FIG. 5(a) and FIG. 5(b), a method comprising the steps of: collecting and twisting thousands to hundreds of thousands of polyacrylonitrile carbon filaments to obtain a carbon filament wire 61 as a collected and twisted body; coating the surface of the carbon filament wire 61 with a synthetic fluororesin and synthetic silicon rubber, thereby obtaining a single-layer coated body having an insulating fluororesin tape 62 and insulating silicon resin 63 thereon as a first coating layer; braiding and incorporating a copper wire over the surface of the single-layer coated body to obtain a coaxial body with the filament wire 61, thereby forming a double-layer coated body having a steel-like copper wire braided body 64 as a second coating layer over the silicon resin 63; further coating the copper wire braided body 64 with an insulating coating resin, thereby obtaining a triple-layer coated body having an insulating coating resin 65 as a third coating layer; and giving treatment to the end of the obtained triple-layer coated body so that it can be connected with an electric supply source such as an electric cable without the intermediary of a lead wire. This embodiment makes it possible to obtain a coaxial cable 60 (its end portion is not shown in the relevant drawings).

[Elastic Device]

This invention can also provide an elastic device made by mounting an elastic body on the carbon filament insulator obtained by the insulating methods of the first and second inventions or on the coaxial cable obtained by the coaxial body forming method of the third invention. Such elastic device can be exploited for all-purpose use as a multipurpose elastic device, for example, like a multi-spring heater. Specifically, the elastic device of this invention can be used without any problems even in rounded areas or in areas where friction is generated if the elastic device is used at joint portions of rain gutters or is buried and used in concrete, asphalt, roads, roofs of platforms or the like. Moreover, the elastic device is useful because it has various capabilities of, for example, thermal diffusion and water conveyance.

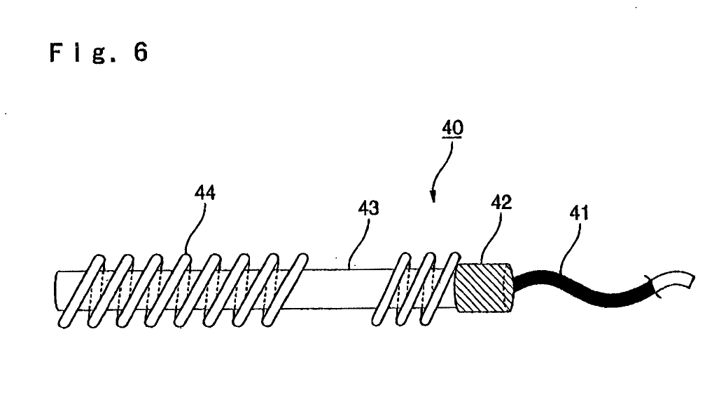

An example of a preferred embodiment of this elastic device is, as shown in FIG. 6, a spring heater having a spring mounted cable 40 made by mounting a spring 44, which is made of stainless material, steel material or the like, around a coaxial cable 43. With this spring heater, the end of the coaxial cable 43 is connected through its connection end 42 with a power supply cord 41 as a power supply cable for supplying electricity to the coaxial electric conductor braided body of the cable 43.

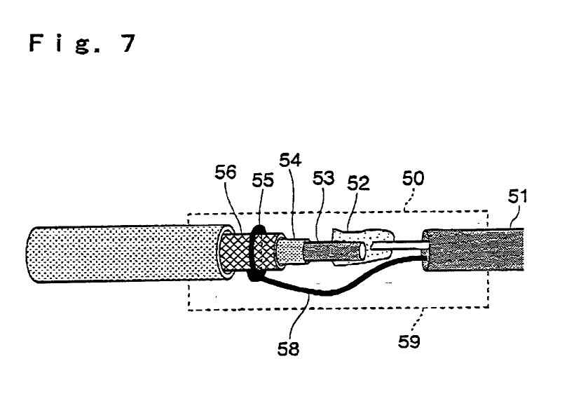

More specifically speaking, the connection end 42 of the spring mounted cable 40 of the spring heater is connected by the following connection method: as shown in FIG. 7, a coaxial cable comprising a carbon filament wire 53, a resin layer 54 as the first coating layer and a coaxial copper wire braided body 56 as a second coating layer is connected with a power supply cable 51 of a single-phase two-core type having core wires 58 and 59 at its end. Specifically, the end of the carbon filament wire 53 of the coaxial cable and the core wire 59 of the power supply cable are connected to each other at a crimp connection part 52, and the coaxial copper wire braided body 56 of the coaxial cable is compressed and connected, over the surface of the end of the braided body 56, with the end 55 of the core wire 58 of the power supply cable. The area 50 surrounded by a dotted line in FIG. 7 indicates the area to which waterproof and insulation treatment is given at the connection part of the coaxial cable end and the power supply cable end.

All the devices of this invention have the effect of inhibiting the generation of bacteria (such as Staphylococcus aureus, salmonella, coli bacillus, general viable cells, and Escherichia coli 0157) and cause no generation of electromagnetic waves.

EXAMPLES

More detailed explanations about this invention are hereinafter given with reference to examples. However, this invention is not limited to the following examples.

### Example 1

Two bundles of polyacrylonitrile carbon filaments (product name “BESFIGHT,” manufactured by Toho Rayon Co., Ltd) (a fiber diameter of 7 μm and a fiber length of 3,000 m), each bundle consisting of 3,000 pieces of filaments and accordingly the two bundles amounting to a total of 6,000 pieces, which were twisted 150 times per meter, thereby obtaining a collected and twisted body (thickness: 0.88 mm) as shown in FIG. 1.

An epoxy resin was then sprayed with the addition of heat over the surface of the collected and twisted body to form a first coating layer with a thickness of 0.05 mm, thereby obtaining a single-layer coated body.

Subsequently, electron beam irradiation sheath processing was performed by heating a colloidal crosslinked polyethylene resin in a treatment vessel at a temperature of 180° C. and applying such resin over the surface of the first coating layer of the single-layer coated body to form a second coating layer with a thickness of 0.7 mm, thereby obtaining a double-layer coated body.

A vinyl chloride resin was then applied or radiated over the surface of the second coating layer of this double-layer coated body to form a third coating layer with a thickness of 0.5 mm, thereby obtaining a triple-layer coated body having the first, second, and third coating layers. The thickness of the obtained triple-layer coated body was 1.978 mm.

Terminal finishing and electrode treatment (insulation sealing treatment to electrode parts) were applied to the triple-layer coated body, which was then used as a carbon filament heater element and was attached with a heater design to a PET film surface and a resin net surface (80 cm×100 cm) so that power consumption would measure 700 W per 1 m².

When an insulation measuring apparatus was used to apply 1000V DC to the heater and the insulation resistance in the air was measured, the indicated result was 2000M Ω, OL and the insulation value was infinite.

Moreover, when the heater was soaked in a tank for 10 days, that is, for 240 hours with the application of 1000V DC and the insulation value was measured, the indicated result was 2000 MΩ, OL and the insulation value was infinite.

Furthermore, as a result of continuous energization of the heater outdoors for two months, the indicated result was 2000 MΩ, OL, the insulation value was infinite, and the insulation was completely maintained. A heater temperature used in this example was 80° C.

### Example 2

The triple-layer coated body manufactured in the same manner as in Example 1 was used as the carbon filament heater element, to which press molding was then applied by using rubber chips having a pulverized rubber block size of 3 mm to 5 mm, thereby obtaining a mat-shaped heater. This heater was continuously energized for one month, during which service water was sprinkled on the mat surface from five times to seven times a day. One month later, the mat was soaked in a tank and a voltage of 1000V DC was applied to the mat and the insulation value was measured. The insulation resistance value was indicated as 2000 MΩ, OL and was infinite.

### Example 3

A single-layer coated body having a resin coating layer with a thickness of 0.05 mm (corresponding to the first coating layer in Example 1) was obtained in the same manner as in Example 1, except that 3,000 pieces of polyacrylonitrile carbon filaments were collected.

The braiding process of silica glass fibers was then applied lengthwise and widthwise over the surface of the resin coating layer of the single-layer coated body, thereby forming a fiber braided body.

Lamination press processing was then applied to this fiber braided body by using soft glued laminated mica to obtain a carbon heater element, which made a heater (or heating and heat insulating device) designed for the power consumption of 100 W.

When the insulation measurement of this heater was conducted in the air, the indicated result was 2000 MΩ, OL. Moreover, this heater was put in a stainless case, both ends of which were sealed with a silicon resin. After continuous energization for 24 hours, the case was put in a tank and more continuous energizing was conducted in the water for 21 days (at a heater temperature of 180° C.). On the 22^{nd} day, the insulation value in the water was measured with the application of a voltage of 1000V DC. The indicated result was 2000 MΩ, OL and the insulation value was infinite.

### Example 4

One hundred twenty thousand (120,000) pieces of polyacrylonitrile carbon filaments (product name “BESFIGHT,” manufactured by Toho Rayon Co., Ltd) having a fiber diameter of 7 μm and a fiber length of 2,500 m were collected and twisted 180 times per meter, thereby obtaining a collected and twisted body (thickness: 4 mm) as shown in FIG. 1.

The surface of this collected and twisted body was wound and covered with a Teflon tape to form a first coating layer with a thickness of 0.5 mm, thereby obtaining a single-layer coated body.

Subsequently, electron beam irradiation sheath processing was performed on the surf ace of the first coating layer of this single-layer coated body by heating silicon rubber in a treatment vessel at a temperature of 180° C. to form a second coating layer with a thickness of 4 mm, thereby obtaining a double-layer coated body. The thickness of the obtained double-layer coated body was 8 mm.

This double-layer coated body w as attached with a heater design to the surface of a resin net (50 cm×230 cm) s o that power consumption would be 700 W per 1 m², and the double-layer coated body was used as a carbon filament heater element, thereby manufacturing a heater (or heating and heat insulating device). This heater was placed on a concrete surface, to which mortar was then directly poured with a thickness of 70 mm. After the curing of the mortar for two weeks, when the insulation resistance value of the heater was measured, the indicated result was 2000 MΩ, OL. Subsequently, experiments were conducted for a period of three months under severe conditions, for example, by turning an ON/OFF switch every five minutes, passing an overcurrent (7A to 9A), or suddenly increasing the heater temperature to 200° C. or more. The insulation resistance value was measured every time the above-described experiments were conducted, and the measured value never turned out to be less than 2000 MΩ.

### Example 5

The respective heater (surface temperature: from 30° C. to 55° C.) as the heating and heat insulating device using the carbon filaments to which the insulation treatment was given in Examples 1 through 4 were used to heat and thermally insulate food products which are commercially available (such as rice balls, lunch baskets, tempura, fried cutlets, and chicken broiled with soy sauce) respectively for five to six hours at the above-mentioned temperatures. They were then tested to see whether any bacteria existed in each food product and whether there would be any change in the number of bacteria, and to examine the state and tastes of each food product.

As a result, with any heaters obtained from Examples 1 through 4, the results of all the bacteria tests were negative with regard to Staphylococcus aureus, salmonella, coli bacillus, general viable cells, Escherichia coli 0157, and other bacteria in each food product. The number of bacteria before the tests began and after five to six hours of heating and heat insulation did not change. The respective food products were not oxidized and tasted better.

### Example 6

Regarding each heater as the heating and heat insulating device using the carbon filaments to which the insulation treatment was given in Examples 1 through 4, tests were conducted by a VCC method to see whether or not electromagnetic waves would be generated at the time of energization and non-energization. As a result, all the heaters obtained from Examples 1 through 4 generated no electromagnetic waves either upon energization or non-energization.

### Example 7

The heater using the coaxial cable as shown in FIG. 5 and the heater as the spring elastic device as shown in FIG. 6 were used and tested, as in Examples 5 and 6, to see whether any bacteria existed in the food products and whether there would be any change in the number of bacteria, and to examine the state and taste of the food products and whether electromagnetic waves would be generated. As a result, in both cases of the heater using the coaxial cable and the heater as the spring elastic device, such advantageous effects were confirmed as are similar to those of the heaters obtained from Examples 1 through 4.

[Effects of the Invention]

By the carbon filament insulating method of this invention, it is possible to provide an insulator which prevents an insulating material from peeling off due to thermal expansion or air expansion, which realizes the enhanced insulation performance and further enhances waterproofness, and which is electrically stable, and to provide a device using the above-described insulator as a heater element.

By the carbon filament insulating method of this invention, it is particularly possible to provide an insulator which prevents the insulating material from peeling off due to thermal expansion or air expansion, which realizes the enhanced insulation performance and incombustibility, which is electrically stable even in high temperature areas at temperatures of 200° C. or more, particularly 300° C. or more, and which can be utilized at public facilities or the like, and it is also possible to provide a device using the above-described insulator as a heater element.

Moreover, by the coaxial body forming method of this invention, it is possible to provide a coaxial cable which requires substantially no use of any lead wire and which is slimly shaped and can enhance the workability.

Furthermore, this invention can provide an elastic device which can be exploited for all-purpose use.

This invention can further provide a device which has the effect of inhibiting the generation of bacteria in foods and causes no generation of electromagnetic waves.

What is claimed is:

1. A carbon filament insulating method comprising:
a collecting and twisting step of collecting and twisting thousands to hundreds of thousands of polyacrylonitrile carbon filaments, thereby forming a collected and twisted body;
a first coating step of coating the surface of the collected and twisted body with a synthetic polymer resin, thereby forming a single-layer coated body having a first coating layer; and
a second coating step of coating the surface of the single-layer coated body with a synthetic polymer resin, thereby forming a double-layer coated body having a second coating layer over the first coating layer.

2. A carbon filament insulating method according to claim 1, wherein the thickness of the first coating layer ranges from 0.05 mm to 1 mm and the thickness of the second coating layer ranges from 0.5 mm to 10 mm.

3. A carbon filament insulating method according to claim 1, further comprising a third coating step of coating the surface of the second coating layer with a synthetic polymer resin, thereby forming a triple-layer coated body having a third coating layer.

4. A carbon filament insulating method according to claim 1, wherein the synthetic polymer resin for forming the first coating layer, the second coating layer, and the third coating layer is one or more kinds of resins selected from a group consisting of epoxy resin, fluororesin, silicon resin, polyethylene resin, polybutylene terephthalate resin, polylimide resin, polyamide resin, vinyl chloride resin, polyurethane resin, polyvinyl chloride elastomer, polyurethane elastomer, chloroprene rubber, silicon rubber, fluororubber, and polyurethane rubber.

5. A carbon filament insulating method comprising:
a collecting and twisting step of using a plurality of filament collected bodies formed by collecting polyacrylonitrile carbon filaments so as to collect a total of thousands to hundreds of thousands of such carbon filaments, and then twisting the carbon filaments, thereby forming a collected and twisted body;
a resin coating step of coating the surface of the collected and twisted body with a synthetic polymer resin, thereby forming a single-layer coated body having a resin coating layer; and
an incombustible treatment step of applying a braiding process to the surface of the single-layer coated body by braiding, lengthwise and widthwise, more than one kind of fiber selected from a group consisting of glass fibers, silica glass fibers, alumina fibers, and aramid fibers, thereby forming a fiber braided body.

6. A carbon filament insulating method according to claim 5, wherein the thickness of the resin coating layer ranges from 0.05 mm to 1 mm.

7. A carbon filament insulating method according to claim 5, further comprising a waterproof coating step of coating the surface of the resin coating layer and the fiber braided body with a synthetic polymer resin, thereby forming a triple-layer coated body having a waterproof coating layer.

8. A carbon filament insulating method according to claim 7, wherein the synthetic polymer resin is more than one kind of resin selected from a group consisting of silicon resin, fluororesin, polyimide resin, and polyethylene resin.

9. A carbon filament insulating method according to claim 5, further comprising a lamination pressing step of applying lamination press processing by using hard or soft glued laminated mica.

10. A carbon filament insulator to which insulation treatment is applied by the insulating method as in any one of claims 1 through 9.

11. A device characterized by the use of the carbon filament insulator, as a heater element, to which insulation treatment is applied by the insulating method as in any one of claims 1 through 9.

12. A method for forming a coaxial body with carbon filaments and an electric conductor, comprising:
a collecting and twisting step of collecting and twisting thousands to hundreds of thousands of polyacrylonitrile carbon filaments, thereby forming a collected and twisted body;
a first coating step of coating the surface of the collected and twisted body with a synthetic polymer resin, thereby forming a single-layer coated body having a first coating layer;
a second coating step of braiding and incorporating an electric conductor over the surface of the single-layer coated body, thereby forming a double-layer coated body having a second coating layer made of an electric conductor braided body over the first coating layer; and
a third coating step of coating the surface of the double-layer coated body with a synthetic polymer resin, thereby forming a triple-layer coated body having a third coating layer over the second coating layer;
wherein by the coaxial body forming method, connection with an electric supply source can be made without the intermediary of a lead wire.

13. A coaxial cable processed by the coaxial body forming method according to claim 12.

14. A device characterized by the use of a coaxial cable, as a heater element, which is processed by the coaxial body forming method according to claim 12.

15. An elastic device formed by mounting an elastic body on a carbon filament insulator, to which insulation treatment is applied by the insulating method as in any one of claims 1 through 9, or a coaxial cable processed by the coaxial body forming method according to claim 12.
